(19) United States
(12) Patent Application Publication
(10) Pub. No.: US 2016/0147034 A1
(43) Pub. Date: May 26, 2016

(54) COOLING STRUCTURE OF SEALED CASING AND OPTICAL APPARATUS USING THE SAME

(71) Applicant: NEC CORPORATION, Tokyo (JP)

(72) Inventors: Akira SHOUJIGUCHI, Tokyo (JP); Minoru YOSHIKAWA, Tokyo (JP); Hitoshi SAKAMOTO, Tokyo (JP); Masaki CHIBA, Tokyo (JP); Kenichi INABA, Tokyo (JP); Arihiro MATSUNAGA, Tokyo (JP)

(73) Assignee: NEC Corporation, Tokyo (JP)

(21) Appl. No.: 14/904,450

(22) PCT Filed: Jul. 16, 2014
(86) PCT No.: PCT/JP2014/003755

§ 371 Date: Jan. 12, 2016

(30) Foreign Application Priority Data
Jul. 19, 2013 (JP) 2013-150425

(51) Int. Cl. G02B 7/02; G03B 21/16; F28D 15/02; G02B 27/00

(52) U.S. Cl. CPC G02B 7/028; G02B 27/0006; G03B 21/16; F28D 15/02

(57) ABSTRACT

A cooling structure of a sealed casing according to the present invention includes sealed containers for housing heat-generation components irradiated with light from a light source to generate heat, an evaporation unit disposed in the sealed container to store a refrigerant, a condensation unit configured to liquefy the refrigerant gasified by the heat received from the heat-generation component, a steam pipe configured to connect the evaporation unit and the condensation unit, through which the gasified refrigerant flows, and a liquid pipe configured to connect the evaporation unit and the condensation unit to each other, through which the liquefied refrigerant flows. Thus, a cooling structure capable of preventing performance deterioration of a cooling target device can be achieved.

### TECHNICAL FIELD

The present invention relates to a cooling structure of a sealed casing, and an optical apparatus using the same, and more particularly to a cooling structure of a sealed casing of an optical apparatus high in heat generation amount and deteriorated in performance or life due to dust.

### BACKGROUND ART

In an optical device such as a LCD (Liquid Crystal Display) using optical components, incursion of dust into the device causes performance deterioration such as reduction of luminance, reduction of a light quantity, or a change of a reproduced color. It is difficult to repair the optical device, and thus the incursion of dust into the optical device substantially ends a product life. Therefore, securing dust-proofness is an important task for the optical component.

In recent years, along with the popularization of optical devices on a global scale, the optical devices have been used in various environments. Among them, in a severe environment such as a desert climate there is a problem of easier incursion of dust into the optical device.

In addition, in recent years, a demand for performance such as high luminance required of such an optical device has increased. When irradiated with high-luminance light, the heat generation amount of an optical component tends to increase. To deal with this, a device is known which includes a cooling fan to cool the optical component. However, when an air volume of the cooling fan is increased to enhance cooling performance of the optical device, a problem of easier incursion of dust into the optical device is created.

One of the methods for solving the aforementioned problems is a liquid crystal projector described in PTL 1, which includes a liquid cooler installed in a body instead of using a cooling fan. According to this projector, the liquid cooler is disposed to circulate liquid in the projector body to come into contact with a liquid crystal display, and further includes an electronic cooling element. When the liquid crystal display generates heat, the liquid in the liquid cooler is heated from its contact part with the liquid cooler. The heated liquid naturally circulates in the liquid cooler to transport the heat of the liquid crystal display. The electronic cooling element cools the heated liquid. The liquid cooled by the electronic cooling element is circulated again in the liquid cooler.

Technique related to the present invention are also disclosed in PTLs 2 and 3.

### CITATION LIST

### Patent Literature

[PTL 1] Japanese Laid-open Patent Publication No. H04-73733 A

[PTL 2] Japanese Laid-open Patent Publication No. 2012-57902 A

[PTL 3] Japanese Laid-open Patent Publication No. 2012-37185 A

### SUMMARY OF INVENTION

### Technical Problem

In the liquid crystal projector described in PTL 1, while light from a light source passes through the liquid cooler, a refractive index of the light changes due to a flow of fluid of the liquid cooler, causing light scattering. Consequently, a shadow is created, which is a problem.

In addition, bubbles in the liquid cooler cause shadows. In order to prevent generation of bubbles in the liquid cooler, the following conditions must be met: first, bubbles are not dissolved in liquid from the time of liquid sealing; and second, liquid from which no steam is generated must always be used in an operation environment of the liquid cooler. However, selection of such a material has proved to be difficult.

There has also been a problem of reliability with regard to liquid sealing in a transparent container. In the case of liquid that is not insulative, an electric failure may occur due to liquid leakage. Even in the case of insulative liquid, a panel failure may occur due to disabled cooling.

Thus, in the related cooling structure, depending on the arrangement of the cooling structure, a problem of deteriorated performance of a cooling target device has occurred.

The present invention is directed to a cooling structure of a sealed casing capable of solving the aforementioned problems. Specifically, the object of the present invention is to provide a cooling structure of a sealed casing capable of solving the problem of deteriorated performance of a cooling target device created depending on the arrangement of the cooling structure, and an optical apparatus using the same.

### Solution to Problem

A cooling structure of a sealed casing according to the present invention includes sealed containers for housing heat-generation components irradiated with light from a light source to generate heat, an evaporation unit disposed in the sealed container to store a refrigerant, a condensation unit configured to liquefy the refrigerant gasified by the heat received from the heat-generation component, a steam pipe configured to connect the evaporation unit and the condensation unit, through which the gasified refrigerant flows, and a liquid pipe configured to connect the evaporation unit and the condensation unit, through which the liquefied refrigerant flows.

An optical apparatus using a cooling structure of a sealed container according to the present invention includes, in a casing, a light source, heat-generation components irradiated with light from the light source to generate heat, sealed containers for housing the heat-generation components, an evaporation unit disposed in the sealed container to store a refrigerant, a condensation unit configured to liquefy the refrigerant gasified by the heat received from the heat-generation component, a steam pipe configured to connect the evaporation unit and the condensation unit, through which the gasified refrigerant flows, and a liquid pipe configured to connect the evaporation unit and the condensation unit, through which the liquefied refrigerant flows.

### Advantageous Effects of Invention

According to the cooling structure of the sealed casing of the present invention, the cooling structure capable of preventing performance deterioration of the cooling target device can be achieved.

### BRIEF DESCRIPTION OF DRAWINGS

FIG. 1 is a sectional view illustrating a configuration of a cooling structure of a sealed casing according to a first exemplary embodiment of the present invention.

FIG. 2 is a sectional view illustrating another configuration of the cooling structure of the sealed casing according to the first exemplary embodiment of the present invention.

FIG. 3 is a sectional view illustrating a configuration of a cooling structure of a sealed casing according to a second exemplary embodiment of the present invention.

FIG. 4 is a sectional view illustrating a configuration of a cooling structure of a sealed casing according to a third exemplary embodiment of the present invention.

FIG. 5 is a sectional view illustrating a configuration of a cooling structure of a sealed casing according to a fourth exemplary embodiment of the present invention.

### DESCRIPTION OF EMBODIMENTS

Hereinafter, the exemplary embodiments of the present invention will be described with reference to the drawings.

### First Exemplary Embodiment

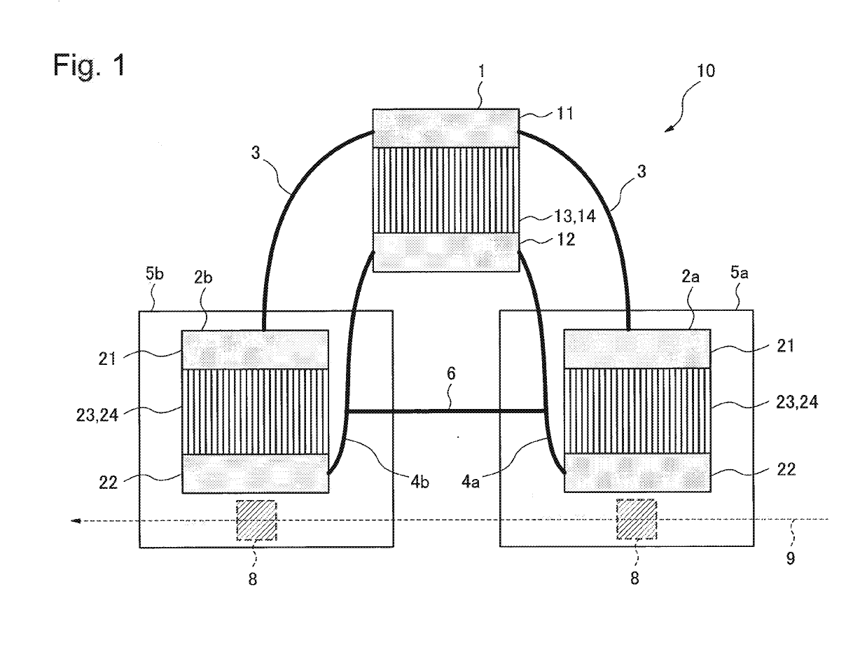

A first exemplary embodiment of the present invention will be described. FIG. 1 is a sectional view illustrating a configuration of a cooling structure of a sealed casing according to the exemplary embodiment. In FIG. 1, the cooling structure 10 of the sealed casing according to the exemplary embodiment includes a condensation unit 1, two evaporation units 2a and 2b, steam pipes 3 through which refrigerant vapor flows, liquid pipes 4a and 4b through which a liquid-phase refrigerant flows, and a liquid pipe connection unit 6. The liquid pipe connection unit 6 connects the liquid pipe 4a and the liquid pipe 4b. The condensation unit 1 includes, for example, a radiator.

The two evaporation units 2a and 2b are respectively arranged in two sealed units 5a and 5b installed in the casing. The cooling structure according to the exemplary embodiment transports heat out of the sealed units 5a and 5b. The steam pipes 3 connect a steam port of the condensation unit 1 and steam ports of the evaporation units 2a and 2b. The liquid pipes 4a and 4b respectively connect liquid pipe ports of the evaporation units 2a and 2b and a liquid pipe port of the condensation unit 1.

Next, internal configurations of the condensation unit 1 and the evaporation units 2a and 2b will be described. Note that basic configuration of the condensation unit 1 and the evaporation units 2a and 2b are the same.

As illustrated in FIG. 1, the condensation unit 1 is configured by including an upper header 11, a lower header 12, a plurality of connection pipe units 13, and a plurality of fin units 14. Similarly, each of the evaporation units 2a and 2b is configured by including an upper header 21, a lower header 22, a plurality of connection pipe units 23, and a plurality of fin units 24. In a vertical direction, the upper headers 11 and 21 are arranged higher than the lower headers 12 and 22.

The connection pipe unit 13 of the condensation unit 1 connects the upper header 11 and the lower header 12. A plurality of connection pipe units 13 is provided.

The connection pipe unit 23 of a heat releasing unit 2 connects the upper header 21 and the lower header 22. A plurality of connection pipe units 23 is provided.

Each fin unit 14 is provided between the connection pipe units 13. Each fin unit 14 takes away the heat from high-temperature air, and conducts the received heat to a refrigerant in the connection pipe unit 23. The received refrigerant changes from a liquid phase to a gas phase to ascend in the connection pipe unit 13.

As in the case of the fin unit 14, the fin unit 24 is provided between the connection pipe units 23. The fin unit 24 releases heat from a refrigerant of a gas phase entered through the upper header 21. The heat-released refrigerant changes from the gas phase to a liquid phase to descend in the connection pipe unit 23 toward the lower header 22.

Each of the fin units 14 and 24 includes a plurality of fins, and configured so that air can be passed among the plurality of fins.

A steam pipe port of the condensation unit 1 is positioned higher than a liquid pipe port of the condensation unit 1 in the vertical direction. A steam pipe port of each of the evaporation units 2a and 2b is positioned higher than a liquid pipe port of each of the evaporation units 2a and 2b. The liquid pipe port of the condensation unit 1 is positioned higher than the steam pipe ports of the evaporation units 2a and 2b in the vertical direction. A refrigerant amount is determined based on a maximum heat generation amount of a cooling target device. After sealing of a refrigerant in the cooling structure 10, vacuuming is carried out to maintain saturated steam pressure of the refrigerant in the cooling structure 10. A connection position of the liquid pipe connection unit 6 is set lower than an air-liquid interface of refrigerant liquid.

The sealed units 5a and 5b can be provided for each heat-generation component 8 in the casing. This arrangement enables reduction of volumes of the sealed units 5a and 5b. As a result, heat transfer is easier in each of the sealed units 5a and 5b, thus enabling efficient cooling of the heat-generation component 8.

The heat-generation component 8 is, for example, an optical component such as a lens. The heat-generation components 8 are provided near the evaporation units 2a and 2b of a cooling device 10 in the sealed units 5a and 5b. In this case, the heat-generation components 8 and the evaporation units 2a and 2b do not come into contact with each other. In this case, the evaporation units 2a and 2b can receive heat from the heat-generation components 8 via warm air in the sealed units 5a and 5b (radiated heat of the heat-generation components 8).

Accordingly, the evaporation units 2a and 2b can receive heat from the heat-generation components 8 without any performance deterioration of cooling target devices (heat-generation components 8) such as damaging of the heat-generation components 8 that are the cooling target devices. In addition, since the evaporation units 2a and 2b do not block light flux 9, the heat-generation components 8 can be cooled without any performance deterioration of the cooling target devices (heat-generation components 8).

The configuration of the exemplary embodiment is useful for a device that includes a plurality of components requiring dust prevention. For example, in an optical apparatus such as a high-luminance projector, some components (e.g., lens) must be sealed to be protected because of large performance deterioration caused by dust. In addition, there are components for which the casing is desirably structured to be openable/closable to enable component replacement or the like. The configuration of the exemplary embodiment can meet both of the conditions. In other words, failures can be made difficult by sealing and protecting a plurality of components large in performance deterioration due to dust. At the same time, components not requiring any consideration for performance deterioration can be replaced or the like by opening/closing the casing.

When the optical apparatus is activated, the heat-generation component 8 in the sealed unit generates heat by the light flux 9 from the light source (not illustrated). At this time, heat generation amounts may be considerably different between the sealed unit 5a and the sealed unit 5b. For example, when the heat generation amount in the sealed unit 5a is larger than that in the sealed unit 5b, a liquid-phase refrigerant on the evaporation unit 2a side is gasified greater than that on the evaporation unit 2b side, and thus reduction is greater. Generally, when a liquid amount of a refrigerant transporting heat is lacking, cooling performance declines while a temperature of a cooling target rises. When the liquid amount of a refrigerant is excessive, due to an increase of internal pressure caused by reduction of a volume occupied by a gas-phase refrigerant, a boiling point rises to deteriorate cooling performance.

In the cooling structure of the exemplary embodiment, the liquid pipe connection unit 6 connects the liquid pipes 4a and 4b, and thus heights of liquid levels in the lower headers 22 of the evaporation units 2a and 2b are adjusted to be equal. Specifically, when a liquid amount of a refrigerant in one of the evaporation units 2a and 2b is lacking, a refrigerant is supplied from the other of the evaporation units 2a and 2b. When the liquid amount of a refrigerant in one of the evaporation units 2a and 2b is excessive, the refrigerant is distributed to the other of the evaporation units 2a and 2b. Accordingly, deterioration of the cooling performance caused by the excess/shortage of the liquid-phase refrigerant can be prevented.

In the configuration of the exemplary embodiment, as described above, the cooling structure 10 and the heat-generation component 8 do not directly comes into contact with each other. Accordingly, performance deterioration of the cooling target device (heat-generation component 8) can be prevented. For example, when an optical component that absorbs light from the light source to generate heat is cooled, the evaporation units 2a and 2b can be installed without blocking its optical path, and thus performance deterioration of the cooling target device caused by light scattering or the like can be prevented.

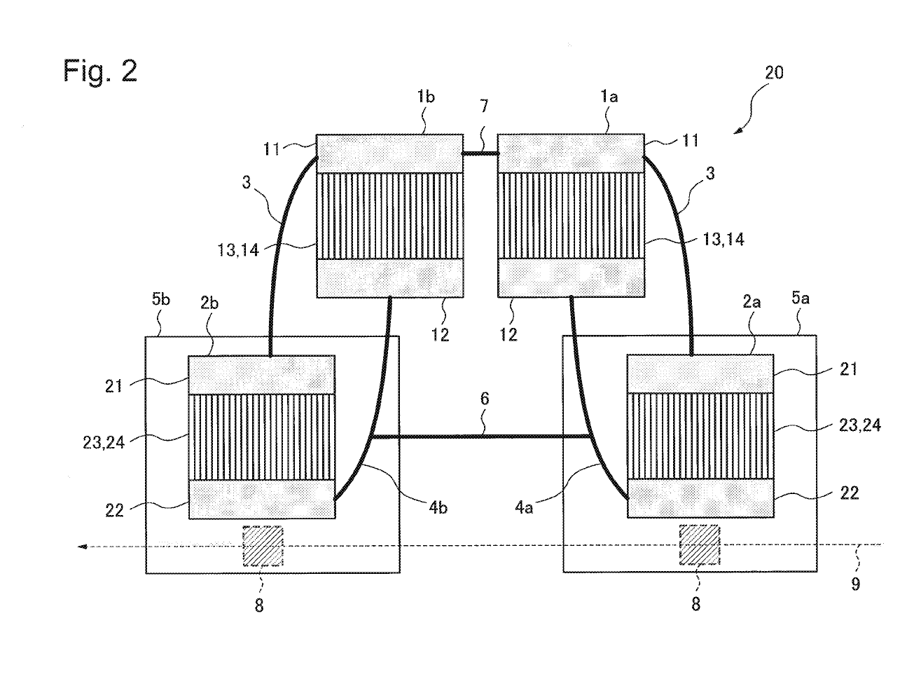

Next, another form of the first exemplary embodiment will be described. FIG. 2 is a sectional view illustrating a cooling structure 20 of a sealed casing according to this exemplary embodiment. The cooling structure 20 of the sealed casing according to the exemplary embodiment includes two condensation units la and lb, two evaporation units 2a and 2b, steam pipes 3, and liquid pipes 4a and 4b. A liquid pipe connection unit 6 connects the liquid pipe 4a and the liquid pipe 4b to each other. In addition, a steam pipe connection unit 7 connects upper headers 11 of the two condensation units la and lb to each other. Accordingly, a gas-phase refrigerant in the condensation unit la and a gas-phase refrigerant in the condensation unit lb can communicate with each other via the steam pipe connection unit 7. As a result, the amount of gas-phase refrigerants in the upper headers 11 of the condensation units la and lb can be made uniform. Note that internal configurations of the condensation units la and lb are similar to those of the condensation unit 1 and the evaporation units 2a and 2b.

As described above, FIG. 2 illustrates the case where the two condensation units 1a and 1b are included. However, a configuration of the exemplary embodiment is not limited to this. Three or more condensation units can be interconnected according to required cooling performance.

Thus, through the configuration where the plurality of condensation units is provided and the plurality of condensation units la and lb are interconnected via the steam pipe connection unit 7, the plurality of evaporation units 2a and 2b are respectively connected directly or indirectly to both the condensation units 1a and 1b. Accordingly, for example, both the condensation units 1a and 1b are configured by including radiators of the same type, and cooling performance can be adjusted based on the number of radiators. This eliminates the necessity of redesigning, according to a heat generation amount of a cooling target, the entire configuration (combination of condensation units or the like) of the individual radiators constituting the condensation units 1a and 1b, and the condensation units 1a and 1b. As a result, costs can be reduced, and a design guideline can be made simple.

The condensation units 1a and 1b are connected to each other via the steam pipe connection unit 7. Accordingly, even when the amounts of gas-phase refrigerants generated by the evaporation units 2a and 2b are nonuniform, the gas-phase refrigerant in the condensation unit la and the gas-phase refrigerant in the condensation unit 1b can communicate with each other via the steam pipe connection unit 7. This enables the amount of gas-phase refrigerants in the upper headers 11 of the condensation units 1a and the condensation unit lb to be uniform. As a result, cooling performance can be maintained. In addition, since the condensation units 1a and 1b are included, and the condensation units 1a and 1b are only required to maintain performance according to a total evaporation quantity as a whole, enlargement of the condensation units 1a and 1b can be suppressed.

### Second Exemplary Embodiment

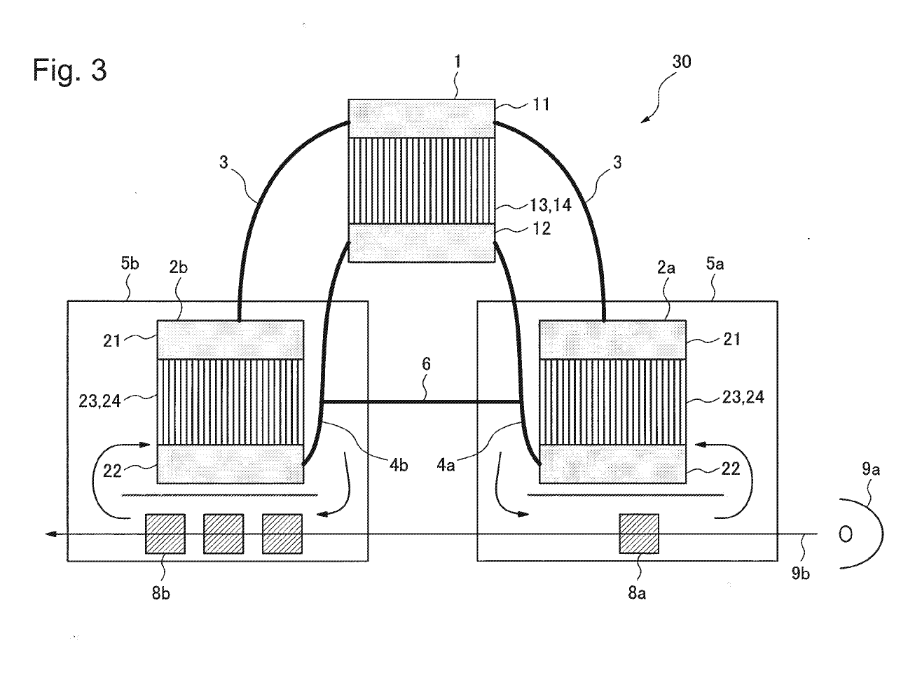

A second exemplary embodiment of the present invention will be described. FIG. 3 is a sectional view illustrating a cooling structure 30 of a sealed casing according to the exemplary embodiment. In the cooling structure 30 of the sealed casing according to the exemplary embodiment, a sealed container houses a plurality of cooling targets. In other words, in at least one sealed container, a plurality of optical components is provided. In an example illustrated in FIG. 3, a plurality of optical components 8b is provided in the sealed container 5b.

In this case, for example, when light flux 9b emitted from a lamp 9a that is a light source is applied to the heat-generation components 8a and 8b that are optical components, the light flux 9b is absorbed by the heat-generation components 8a and 8b. Accordingly, the heat-generation components 8a and 8b generate heat in the sealed containers 5a and 5b. In this case, while a heat generation amount of each of the heat-generation components 8a and 8b increases/decreases depending on an operation state of a cooling target device, a sum total of heat generation amounts is determined by the amount of light from the lamp 9a.

According to the configuration of the exemplary embodiment, cooling performance of the evaporation units 2a and 2b and the condensation unit 1 is determined based on the preset sum total of heat generation amounts, and then according to a location of the cooling target device, the sealed containers 5a and 5b can be arranged without blocking an optical path. This enables the cooling performance to be set to a bare minimum. Accordingly, enlargement of the evaporation units 2a and 2b and the condensation unit 1 can be suppressed. In addition, since the optical path is not blocked, without any performance deterioration of the cooling target device caused by scattering of the light from the lamp 9a, the cooling performance of the cooling structure 30 can be maintained.

### Third Exemplary Embodiment

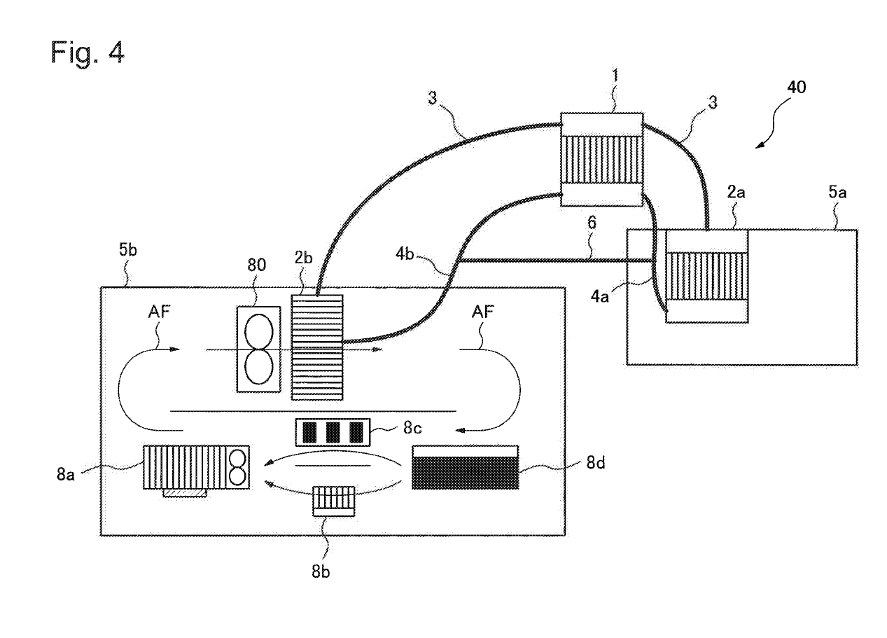

A third exemplary embodiment of the present invention will be described. FIG. 4 is a sectional view illustrating a cooling structure 40 of a sealed casing according to the exemplary embodiment. In the cooling structure 40 of the sealed casing according to the exemplary embodiment, a plurality of heat-generation components 8a, 8b, 8c, and 8d, an evaporation unit 2b, and a fan 80 are housed in a sealed container 5b.

The fan 80 circulates air in the sealed container 5b. In an example illustrated in FIG. 4, the fan 80 circulates air clockwise (right-handed) in the sealed container 5b. Note that since the fan 80 is installed in the sealed container 5b, incursion of dust into the sealed container 5b from the outside can be prevented. Thus, the problem of dust incursion described above in the Background Art can be prevented.

In the cooling structure 40, locations of the evaporation unit 2b and the fan 80 are determined corresponding to locations of the heat-generation components 8a, 8b, 8c, and 8d that are cooling targets. Accordingly, one-way circulating cooling air (air flow) AF is generated with the evaporation unit 2b set as a starting point.

More specifically, a heat-generation component small in allowable temperature rise value and heat generation amount is disposed on an upstream side of the circulating cooling air (air flow) AF with the evaporation unit 2b set as the starting point. A heat-generation component large in heat generation amount is disposed on a downstream side of the circulating cooling air (air flow) AF with the evaporation unit 2b set as the starting point. In FIG. 4, a circulation path of the circulating cooling air AF is formed clockwise (right-handed). Accordingly, the heat-generation components are arranged in an order from a small heat generation amount clockwise (right-handed) along the circulation path of the circulating cooling air AF with the evaporation unit 2b set as the starting point.

In the example illustrated in FIG. 4, it is supposed that a heat generation amount of the heat-generation component 8d is smallest, while a heat generation amount of the heat-generation component 8a is largest, and heat generation amounts of the heat-generation components 8b and 8c are between those of the heat-generation components 8a and 8d. Therefore, as illustrated in FIG. 4, clockwise on the circulation path of the circulating cooling air AF with the evaporation unit 2b set as the starting point, the heat-generation component 8d is installed first, then heat-generation components 8b and 8c are installed, and lastly, the heat-generation component 8a is installed.

When there are many components having small allowable temperature rise values, a plurality of sealed containers 5b is provided, and these components are arranged on the upstream side of the circulating cooling air (air flow) AF with the evaporation unit 2b set as the starting point. This configuration enables further suppression of the air amount of the fan and prevention of dust scattering than a case where circulating cooling air (air flow) AF is formed in the entire casing of the cooling structure 40. As a result, the components can be stably cooled with low noise.

Since heat diffusion is limited in the sealed containers 5a and 5b, efficient heat discharging and efficient cooling is possible. As described above, the sealed containers 5a and 5b can be arranged according to the heat generation amounts of the heat-generation components 8a, 8b, 8c, and 8d. Accordingly, for example, a configuration can be employed where only the heat-generation component having a large heat generation amount is housed in one sealed container to be separated from the other components. As a result, a rise in temperature of the components arranged in the vicinity thereof caused by heat (blast heat) radiated from the heat-generation component having the large heat generation amount can be prevented.

At least one of the sealed containers 5a and 5b may be configured to house a plurality of heat-generation components, and the evaporation units 2a and 2b may be configured to be arranged near a housed position of, among the plurality of heat-generation components, a heat-generation component having a smallest heat generation amount.

Another heating element may be provided between the heat-generation components arranged near the evaporation units 2a and 2b, and a heat generation amount of the heating element may be set smaller than that of any of the plurality of heat-generation components.

The sealed containers 5a and 5b may include heating elements. In this case, the heating elements and the plurality of heat-generation components smaller in heat generation amount may be arranged nearer to the evaporation units 2a and 2b.

### Fourth Exemplary Embodiment

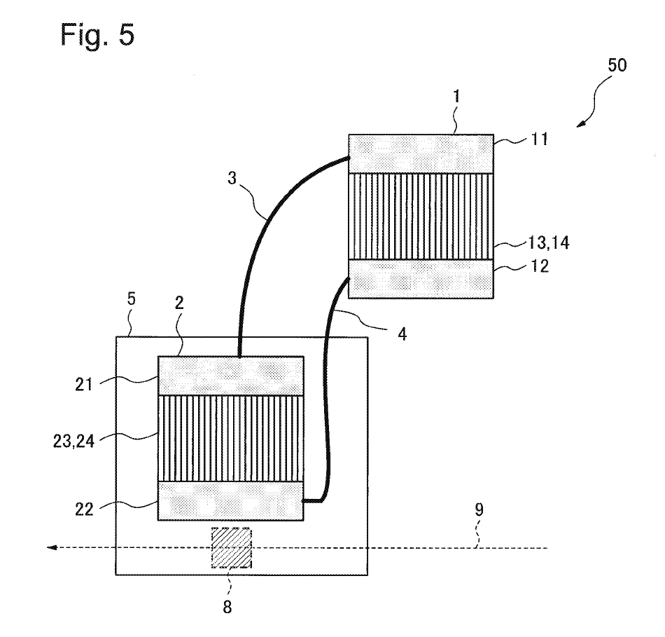

A fourth exemplary embodiment of the present invention will be described. FIG. 5 is a sectional view illustrating a configuration of a cooling structure of a sealed casing according to the exemplary embodiment. In FIG. 5, the cooling structure 50 of the sealed casing according to the exemplary embodiment includes a condensation unit 1, an evaporation unit 2, a steam pipe 3 through which refrigerant vapor flows, and a liquid pipe 4 through which a liquid-phase refrigerant flows. The condensation unit 1 includes, for example, a radiator.

The evaporation unit 2 is disposed in a sealed unit 5 installed in the casing. The cooling structure according to the exemplary embodiment transports heat out of the sealed unit 5. The steam pipe 3 connects a steam port of the condensation unit 1 and a steam port of the evaporation unit 2 to each other. The liquid pipe 4 connects a liquid pipe port of the evaporation unit 2 and a liquid pipe port of the condensation unit 1 to each other.

Internal configurations of the condensation unit 1 and the evaporation unit 2 are similar to those of the condensation unit 1 and the evaporation units 2a and 2b described above. Basic configuration of the condensation unit 1 and the evaporation unit 2 are the same.

After sealing of a refrigerant in the cooling structure 10, vacuuming is carried out to maintain saturated steam pressure of the refrigerant in the cooling structure 10.

A heat-generation component 8 is, for example, an optical component such as a lens. The heat-generation component 8 is provided near the evaporation unit 2 of a cooling device 10 in the sealed unit 5b. In this case, the heat-generation component 8 and the evaporation unit 2 do not come into contact with each other. The evaporation unit 2 can receive heat from the heat-generation component 8 via warm air in the sealed unit 5 (radiated heat of the heat-generation component 8).

Accordingly, the evaporation units 2a and 2b can receive heat from the heat-generation component 8 without any performance deterioration of a cooling target device (heat-generation component 8) such as damaging of the heat-generation component 8 that is the cooling target device.

In addition, for example, when the optical component 8 that absorbs light from a light source to generate heat is cooled, the evaporation unit 2 can be installed without blocking its optical path. Accordingly, performance deterioration of the cooling target device (heat-generation component 8) caused by light scattering or the like can be prevented. In other words, since the evaporation units 2a and 2b do not block light flux 9, without deteriorating performance of the cooling target device (heat-generation component 8), the heat-generation component 8 can be cooled.

The heat-generation component 8 in the sealed unit 5 generates heat by the light flux 9 from the light source (not illustrated).

The configuration of the exemplary embodiment is useful for a device that includes a plurality of components requiring dust prevention. For example, in an optical apparatus such as a high-luminance projector, some components (e.g., lens) must be sealed to be protected because of large performance deterioration caused by dust. In addition, there are components for which the casing is desirably structured to be openable/closable to enable component replacement or the like. The configuration of the exemplary embodiment can meet both of the conditions. In other words, failures can be made difficult by sealing and protecting a plurality of components large in performance deterioration due to dust. At the same time, components not requiring any consideration of performance deterioration can be replaced or the like by opening/closing the casing.

It is needless to say that the present invention is not limited to the aforementioned exemplary embodiments, but various changes can be made within the scope of the invention specified in the appended claims, and that they are within the present invention.

This application claims priority based on Japanese Patent Application No. 2013-150425 filed on Jul. 19, 2013, the entire disclosure of which is incorporated herein.

### INDUSTRIAL APPLICABILITY

The present invention can be applied to, for example, a cooling structure of a sealed casing, and an optical apparatus using the same.

### REFERENCE SINGS LIST

10, 20, 30, 40 Cooling structure
1 Condensation unit
2a, 2b Evaporation unit
3 Steam pipe
4a, 4b Liquid pipe
5a, 5b Sealed unit
6 Liquid pipe connection unit
7 Steam pipe connection unit
8, 8a, 8b, 8c, 8d Heat-generation component
9, 9b Light flux
9a Light source
80 Fan
AF Circulating cooling air (air flow)

1. A cooling structure of a sealed casing comprising:
sealed containers for housing heat-generation components irradiated with light from a light source to generate heat;
an evaporation unit disposed in the sealed container to store a refrigerant;
a condensation unit configured to liquefy the refrigerant gasified by the heat received from the heat-generation component;
a steam pipe configured to connect the evaporation unit and the condensation unit, through which the gasified refrigerant flows; and
a liquid pipe configured to connect the evaporation unit and the condensation unit, through which the liquefied refrigerant flows.

2. The cooling structure of the sealed casing according to claim 1, further comprising:
a plurality of evaporation units; and
a liquid pipe connection unit configured to interconnect a plurality of liquid pipes for connecting the plurality of evaporation units and the condensation unit to each other.

3. The cooling structure of the sealed casing according to claim 1, wherein
the steam pipe connects a steam pipe port of the condensation unit and a steam pipe port of the evaporation unit to each other,
the liquid pipe connects a liquid pipe port of the condensation unit and a liquid pipe port of the evaporation unit to each other,
the steam pipe port of the condensation unit is positioned higher than the liquid pipe port of the condensation unit in a vertical direction,
the steam pipe port of the evaporation unit is positioned higher than the liquid pipe port of the evaporation unit in the vertical direction, and
the liquid pipe port of the condensation unit is positioned higher than the steam pipe port of the evaporation unit in the vertical direction.

4. The cooling structure of the sealed casing according to claim 1, the condensation unit including a plurality of radiators, the cooling structure further comprising a steam pipe connection unit configured to interconnect the plurality of radiators.

5. The cooling structure of the sealed casing according to claim 1, wherein
at least one of the sealed containers houses the plurality of heat-generation components, and
the evaporation unit is disposed near, among the plurality of heat-generation components, a housed position of the heat-generation component lowest in heat generation amount.

6. An optical apparatus using a cooling structure of a sealed container, the cooling structure of the sealed container comprising, in a casing:
a light source;
heat-generation components irradiated with light from the light source to generate heat;
sealed containers for housing the heat-generation components;
an evaporation unit disposed in the sealed container to store a refrigerant;
a condensation unit configured to liquefy the refrigerant gasified by the heat received from the heat-generation component;
a steam pipe configured to connect the evaporation unit and the condensation unit, through which the gasified refrigerant flows; and
a liquid pipe configured to connect the evaporation unit and the condensation unit, through which the liquefied refrigerant flows.

7. The optical apparatus according to claim 6, wherein at least one of the sealed containers houses the plurality of heat-generation components.

8. The optical apparatus according to claim 7, wherein among the plurality of heat-generation components housed in the sealed container, the components lower in heat generation amount are arranged nearer to the evaporation unit.

9. The optical apparatus according to claim 8, further comprising a heating element between the evaporation unit and the heat-generation component disposed near the evaporation unit,
wherein a heat generation amount of the heating element is smaller than that of any of the plurality of heat-generation components.

10. The optical apparatus according to claim 7, wherein
the sealed container further comprises heating elements, and
among the heating elements and the plurality of heat-generation components, the heating elements and the components lower in heat generation amount are arranged nearer to the evaporation unit.
